(19) United States
(12) Patent Application Publication
(10) Pub. No.: US 2007/0172008 A1
(43) Pub. Date: Jul. 26, 2007

(54) Circuit and method for detection of synchronization signal

(75) Inventor: Hiroyuki Shine, Kawasaki (JP)

Correspondence Address: YOUNG & THOMPSON, 745 SOUTH 23RD STREET, 2ND FLOOR, ARLINGTON, VA, 22202, US

(73) Assignee: NEC ELECTRONIC CORPORATION, KAWASAKI (JP)

(21) Appl. No.: 11/651,503

(22) Filed: Jan. 10, 2007

(30) Foreign Application Priority Data
Jan. 24, 2006 (JP) 2006-015145

(51) Int. Cl. H04L 7/00

(52) U.S. Cl. 375/368

(57) ABSTRACT

A synchronization detection circuit in which serial data received is collated to a predetermined matching pattern in a synchronization detection window to generate a detection level having a value corresponding to the degree of conformity to the matching pattern and in case a pattern is detected, whose detection level exceeds a preset threshold value, the pattern so detected is indicative of a synchronization signal. During the time before detection of the synchronization signal pattern, the maximum value of past detection level is retained. In case a pattern of the detection level of a value higher than the maximum value, as retained, is detected, the past detection level is updated and the detection of the pattern corresponding to the detection level of the higher value is considered to indicate detection of a provisional synchronization signal. Accordingly, a reset signal for re-synchronization of data take-in timing is output.

### FIELD OF THE INVENTION

This invention relates to a circuit and a method for detection of synchronization signals. More particularly, this invention relates to a circuit and a method that may be used with advantage for synchronization detection of a recording and/or reproducing apparatus.

### BACKGROUND OF THE INVENTION

As regards the outline of a synchronization signal detection circuit, reference is made to e.g., the disclosure of Patent Document 1. As regards the outline of a DVD-RAM, reference is made to e.g., the disclosure of Patent Document 2.

FIG. 13 shows the configuration of a conventional synchronization signal detection circuit. This synchronization signal detection circuit includes a circuit block 10′, a PS/SYNC pattern detection circuit 20′, a SY0 detection/decision circuit 30′, and a circuit block 40′. The circuit block 10′ includes a read channel for extracting a bit signal from a signal read out from an optical disc, and a header region detection circuit for detecting a header region. The PS/SYNC pattern detection circuit 20′ detects a pre-sync PS/SY0 from serial data read_data. The circuit block 40′ includes a SYNC window control circuit and an ESM data demodulating circuit.

Referring to FIG. 13, read_data is serial data (also termed as read channel data) output from a read channel. The header area detection circuit outputs a synchronization detection window sync0_detect_window, sometimes abbreviated below to ‘sy0win’, for detecting a leading end of a sector, as estimated from the header. The header area detection circuit also outputs sync0_compensation_signal (in) (also abbreviated as ‘sy0cmp_in’), which is a synchronization compensation signal at the leading end of a sector, as estimated from the header.

On detection of a synchronization signal (SY0) at the leading end of a sector, from the serial data read_data, the PS/SYNC pattern detection circuit 20′ outputs sync0_detect_signal (also abbreviated as ‘sync0det’) and, on detection of a PS (Pre Sync) pattern, the PS/SYNC pattern detection circuit outputs ps_detect_signal (‘ps_det). Moreover, on detection of a SYNC pattern from the serial data read_data, the PS/SYNC pattern detection circuit 20′ outputs a sync_detect_signal, (also abbreviated as ‘syncdet’).

The SY0 detection/decision circuit 30′ receives the ps_detect_signal (ps_det), sync0_detect_signal (sy0det) and the sync0_compensation_signal (in) (sy0 cmp_in) to output a synchronization (SY0) detection signal sync0_detect_signal (sy0det). In case the synchronization detection signal sync0_detect_signal (sy0det) cannot be obtained, the SY0 detection/decision circuit 30′ outputs an SY0 compensation signal sync0_compensation_signal (out), sometimes abbreviated to ‘sy0cmp_out’, used as a substitution signal for the SY0 detection signal.

The SYNC window control circuit outputs sync_detect_window to the PS/SYNC pattern detection circuit 20′. The ESM data demodulating circuit outputs ESM (Eight-to-Sixteen modulation) decoded data esm_decode_data.

FIG. 14 depicts a timing chart for illustrating the operation of the circuit shown in FIG. 13, in which the synchronization signal (SY0) at the leading end of a sector cannot be obtained. The ‘sy0 cmp_out’, generated by the SY0 detection/decision circuit 30′, based on the sync0_compensation_signal (in) ‘sy0cmp_in’, generated from a detection signal of a header area of a DVD-RAM, is used as a compensation signal for the synchronization signal SY0 at the leading end of a sector. However, there are occasions where, in case SY0 detection has failed, sy0 cmp_out is not sufficient in accuracy (that is, accuracy in timing) to reproduce sector data by having resort to this sy0cmp_out.

[Patent Document 1] JP Patent Kokai Publication No. JP-P2001-273727A

[Patent Document 2] JP Patent Kokai Publication No. JP-P2000-30270A

### SUMMARY OF THE DISCLOSURE

As described above with reference to FIG. 14, it is difficult to generate a synchronization compensation signal of high accuracy at the leading end of a sector of a DVD-RAM. In case no synchronization signal can be obtained, no highly accurate signal may be obtained which enables readout of correct data, and hence the data of the frame as read out becomes error data. This problem arises mainly on account of the DVD-RAM standard, as will be described later in connection with the description of the present invention.

For solving the above problem, the present invention is constructed substantially as follows:

A synchronization detection circuit for detecting a synchronization signal from input serial data, in accordance with an aspect of the present invention, includes:

a circuit that collates said serial data with a predetermined matching pattern, in a synchronization detection window, and that generates a detection level which takes on a value corresponding to the degree of conformity between said serial data and said matching pattern; and

a circuit that determines a pattern, the detection level of which exceeds a predetermined threshold value, to be a synchronization signal pattern, when such pattern is detected from said serial data.

The synchronization detection circuit according to the present invention further includes:

a circuit that retains a maximum value of a past detection level during the time before detection of a synchronization signal pattern; and

a circuit that updates, on detection of a pattern with a detection level thereof being higher than said maximum value, as retained, said past detection level, and that based on a premise that the detection of the pattern with said higher detection level can be supposed to indicate detection of a provisional synchronization signal pattern, outputs a signal for re-synchronizing data take-in timing.

In the synchronization detection circuit according to the present invention, a bit pattern corresponding to at least a synchronization signal (SY0) at the leading end of a sector is divided into a plurality of regions, as matching patterns, each being of a preset bit length, and scores 1 or 0 are afforded in accordance with coincidence or non-coincidence with a matching pattern in each region, respectively. The sum of the scores for entirety of the regions of the matching patterns is set as the detection level. Alternatively, a bit pattern corresponding to concatenation of a pre-sync pattern provided in a header and a synchronization signal (SY0) pattern at the leading end of a sector is divided into a plural number of regions, as matching patterns, each being of a preset bit length, and scores 1 or 0 are afforded in accordance with coincidence or non-coincidence with a matching pattern in each region, respectively. The sum of the scores for entirety of the regions of the matching patterns is set as the detection level.

In the synchronization detection circuit according to the present invention, the aforementioned synchronization detection window corresponds to a time interval indicating a region with a relatively high probability of detection of the synchronization signal.

A synchronization detection method according to the present invention includes:

generating a synchronization compensation signal on opening of a window for a synchronization signal (SY0) at the leading end of a sector;

detecting a pattern proximate to a synchronization signal and comparing the pattern detected with a pattern detected in the past;

adjusting data take-in timing from said serial data in case the pattern as newly found is determined to be more proximate to the correct synchronization signal; and

setting the synchronization signal, detected by said previous step, as a correct synchronization signal.

A synchronization detection method according to the present invention may include the steps of:

receiving input serial data and a synchronization detection window indicating a region of a high probability of detection of a synchronization signal, as input;

collating said input serial data with a predetermined matching pattern, in the synchronization detection window, and generating a detection level which takes on a value corresponding to the degree of conformity between said serial data and said matching pattern; and

determining a pattern, the detection level of which exceeds a predetermined threshold value, to be a synchronization signal pattern, when such pattern is detected from said serial data.

The synchronization detection method according to the present invention may also include the steps of: retaining a maximum value of a past detection level during the time prior to detection of a synchronization signal pattern; and updating the past detection level in case a bit pattern with the detection level being higher than the maximum value retained is detected, and based on a premise that the detection of the pattern with said higher detection level can be supposed to indicate detection of a provisional synchronization signal pattern, re-synchronizing data take-in timing.

The meritorious effects of the present invention are summarized as follows.

According to the present invention, correctly reproduced data may be obtained, even in case the reproduced signal is inferior in quality such that it is difficult to detect a synchronization signal, as a result of which the drive may be improved in readability.

Still other features and advantages of the present invention will become readily apparent to those skilled in this art from the following detailed description in conjunction with the accompanying drawings wherein embodiments of the invention are shown and described, simply by way of illustration of the mode contemplated of carrying out this invention. As will be realized, the invention is capable of other and different embodiments, and its several details are capable of modifications in various obvious respects, all without departing from the invention. Accordingly, the drawing and description are. to be regarded as illustrative in nature, and not as restrictive.

### BRIEF DESCRIPTIONS OF THE DRAWINGS

FIGS. 1 is a view for illustrating the present invention.

FIG. 2 is a diagram for illustrating the DVD-RAM format.

FIGS. 3 to 7 are diagrams for illustrating the present invention.

FIG. 8 is a block diagram showing the configuration of an example of the present invention.

FIG. 9 is a block diagram showing the configuration of an SY0 detection/decision circuit shown in FIG. 8.

FIG. 10 is a timing chart for illustrating the operation of the example of the present invention.

FIG. 11 is a timing chart for illustrating the resetting operation of the example of the present invention.

FIG. 12 is a schematic view for illustrating the state-of-the-art synchronization detection.

FIG. 13 is a block diagram showing the configuration of a conventional synchronization detection circuit.

FIG. 14 is a timing chart showing the operation of the synchronization circuit of FIG. 13.

FIG. 15 is a diagram for illustrating a synchronization frame of DVD select data.

FIG. 16 is a schematic view showing an error pattern for 14T.

FIG. 17 is a schematic view showing an error pattern for 12-16T.

FIG. 18 is a diagram showing a case where the 14T part of a signal pattern has been deviated by 1T towards back.

FIG. 19 is a diagram showing a case where a part of the signal pattern ahead of the 14T part has been deviated by 1T towards back.

FIGS. 20A and 20B are schematic block diagrams for comparative illustration of the conventional configuration of e.g., Patent Document 1 and the present invention.

### DETAILED DESCRIPTION OF THE INVENTION

The principle of the present invention will now be described. Initially, the sector configuration of the DVD standard will be described. In a DVD, sector data are made up by synchronization frames shown in FIG. 15. The synchronization frames are each made up of a synchronization pattern (SYNC) and frame data.

For a DVD-based recording optical disc, such as DVD-R, DVD+R, DVD-RW, DVD+RW or DVD-RAM, it is prescribed that the mark length as used for recording data is 3T to 11T, and that 14T marks or 14T spaces are included in the SYNC (synchronization pattern).

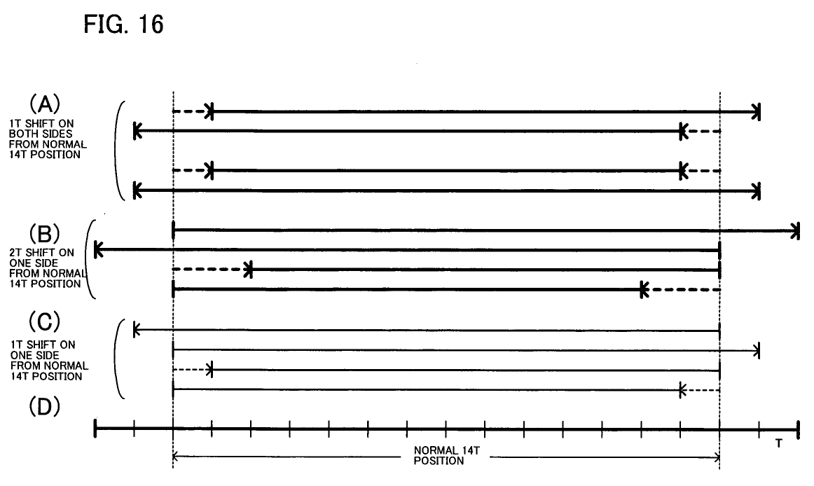

It may be an occurrence that 14T may become an error pattern, such as 13T, other than 14T, depending on readout states, as shown in FIG. 16. That is, 14T may become an error pattern, such as 13T or 15T, due to transition point error, caused by shifting of transition points in the 14T pattern.

(A), (B) and (C) of FIG. 16 schematically show a case where bit shifting has occurred by 1T at both ends in the same direction or in opposite directions, a case where bit shifting has occurred by 2T at one ends, and a case where bit shifting has occurred by 1T at one ends, from a normal 14T position, respectively.

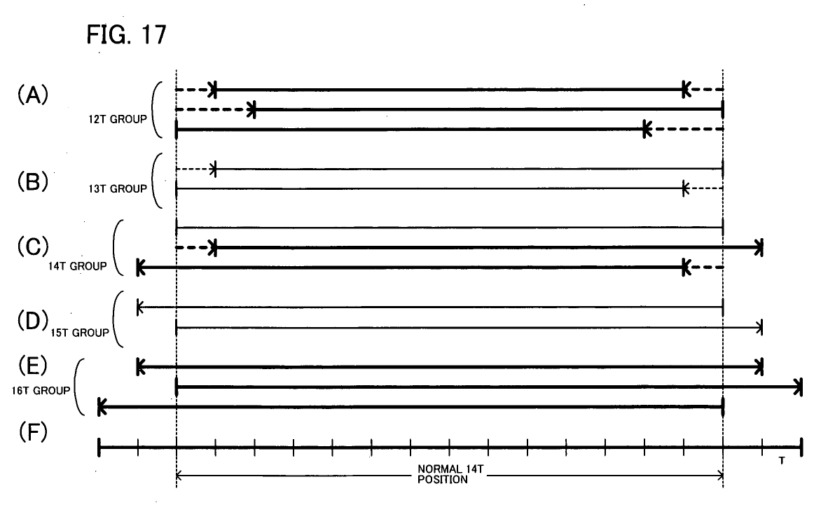

Putting the above in order, and presupposing a 2-bit shift, each of 12T to 16T groups has plural candidates, as shown (A) to (E) of FIG. 17. Examples of SY0 patterns, generated by shifting of 0T to 2T of the 14T pattern, shown in FIG. 17, are tabulated in the following Table 1:

TABLE 1

| | | |
|---|---|---|
| 1 | 12T | 0001_0100_0100_0010_0000_0000_0010_0001 |
| | pattern 1 | |
| 2 | 12T | 0001_0100_0100_0001_0000_0000_0001_0001 |
| | pattern 2 | |
| 3 | 12T | 0001_0100_0100_0100_0000_0000_0100_0001 |
| | pattern 3 | |
| 4 | 13T | 0001_0100_0100_0010_0000_0000_0001_0001 |
| | pattern 1 | |
| 5 | 13T | 0001_0100_0100_0100_0000_0000_0010_0001 |
| | pattern 2 | |
| 6 | 14T | 0001_0100_0100_0100_0000_0000_0001_0001 |
| | pattern 1 | |
| 7 | 14T | 0001_0100_0100_1000_0000_0000_0010_0001 |
| | pattern 2 | |
| 8 | 14T | 0001_0100_0100_0010_0000_0000_0000_1001 |
| | pattern 3 | |
| 9 | 15T | 0001_0100_0100_1000_0000_0000_0001_0001 |
| | pattern 1 | |
| 10 | 15T | 0001_0100_0100_0100_0000_0000_0000_0001 |
| | pattern 2 | |
| 11 | 16T | 0001_0100_0100_1000_0000_0000_0000_1001 |
| | pattern 1 | |
| 12 | 16T | 0001_0100_0100_0100_0000_0000_0000_0101 |
| | pattern 2 | |
| 13 | 16T | 0001_0100_0101_0000_0000_0000_0001_0001 |
| | pattern 3 | |

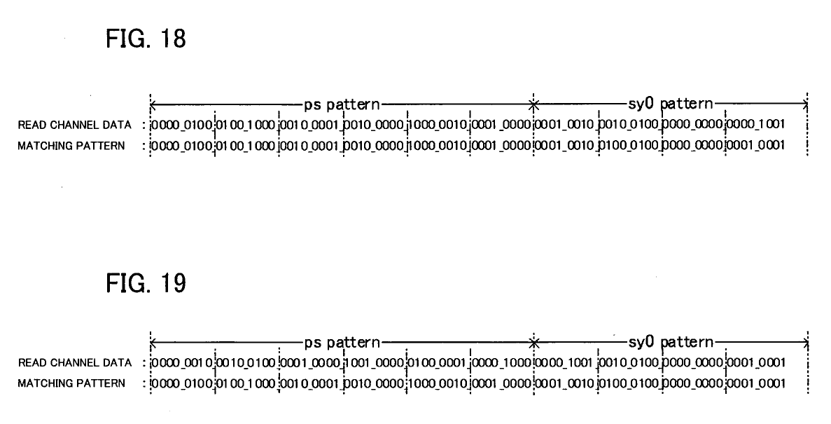

In the above Table 1, the pattern shown in the third column is obtained from a DVD sync pattern by shifting, in a 14T sync pattern part (13 consecutive ‘0’s between two ‘1’s), the ‘1’s representing the points of signal level transition at the time of NRZI signal conversion, as shown in FIGS. 17 and 18. The patterns of deviations from the normal 14T position of the error patterns shown in FIG. 17 may be any of two for 13T (13T pattern 1 and 13T pattern 2), two for 1ST (1ST pattern 1, 1ST pattern 2 and 1ST pattern 3), or three for 12T (12T pattern 1, 12T pattern 2 and 12T pattern 3). In similar manner, the patterns of deviations from the normal 14T position of the error patterns may be any of three for each of 14T and 16T.

The present invention has been made as the above is taken into consideration. If, in detecting a provisional synchronization signal, there are plural signal patterns of the same detection level in the serial data from a read channel, the signal pattern detected first becomes a provisional synchronization signal.

The criteria for detection of the synchronization pattern adopted by to the present invention will now be described. There are two sorts of detection references, that is, a 14T reference and a reference other than the 14T reference. With the 14T reference, it is assumed that, in detecting a synchronization pattern, the location of the 14T pattern in a reproduced channel bit sequence is in correct position relationship with respect to a frame data start position. With the reference other than the 14T reference, it is assumed that the 14T pattern position is shifted and the position relationship between the so shifted 14T pattern position and the frame data start position is not correct so that it is necessary to get a frame data start position from another fixed pattern lying in the circumference of the sync data. For example, with the pattern shown in FIG. 18, the 14T part is shifted by 1T towards the trailing side, such that correct data may be obtained if a reference other than 14T is used as a reference.

In a pattern shown in FIG. 19, the pattern part ahead of the 14T part is shifted by 1T towards the trailing side, such that correct data may be obtained if the 14T reference is used as a reference.

In a provisional synchronization signal, the former case, that is, a case where the 14T part has been shifted by 1T towards the trailing side, is presupposed, and a reference other than the 14T reference is used as reference. In a synchronization signal, the latter case, that is, a case where the pattern part ahead of the 14T part has been shifted towards the trailing side, is presupposed, and the 14T reference is used as reference. This may be accounted for as follows:

That is, the provisional synchronization signal searches for a synchronization signal of a higher detection level and is suited for detecting a synchronization signal from several candidates as it presupposes an error pattern of a 14T pattern.

The synchronization signal is used for determining the timing of the synchronization signal, for which accuracy is a requirement. It is felt that, depending on a particular setting used, the occurrence frequency of erroneous detection of a synchronization signal is lesser in case the 14T reference is used than in case a reference other than the 14T reference is used. It is also felt that the 14T reference is more desirable from the viewpoint of achieving better interchangeability with the intrinsic synchronization detection which is carried out to the exclusion of the PS pattern other than the synchronization signal at the leading end of a sector.

According to the present invention, there is provided detection level generating means in a synchronization detection circuit, receiving serial data, as read out from a read channel, and also receiving a synchronization detection window. The synchronization detection window represents an area with a high synchronization signal detection probability. The detection level generating means generates scores, also termed detection levels, indicating the degree of matching between the serial data and the synchronization signal. The score assumes a maximum value in case the serial data and the synchronization signal coincide with each other within the synchronization detection window. The detection level generating means detects the serial data, the score for which has exceeded a preset threshold value, as a synchronization signal pattern.

During the time previous to detection of the synchronization signal pattern, the synchronization detection circuit holds the maximum value of the past detection level. On detection of a detection level higher than the maximum value of the past detection level, the synchronization detection circuit updates the past detection level and considers the pattern of the higher detection level to be the detection of the provisional synchronization signal pattern to proceed to re-synchronize the data take-in timing.

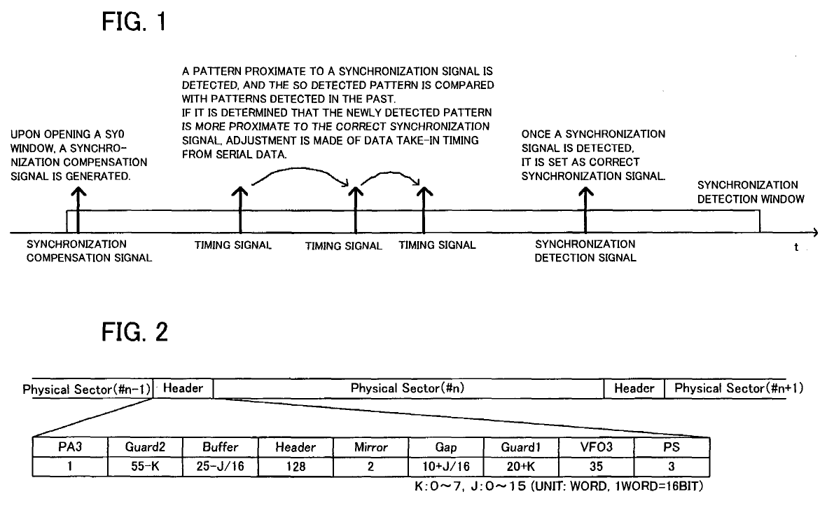

FIG. 1 illustrates the operational principle of the present invention. When the window of the synchronization signal at the leading end of a sector (SY0) is opened, a synchronization compensation signal is generated.

On detection of a pattern, proximate to a synchronization signal, the detected pattern is compared with previously detected patterns. If the newly detected pattern is determined to be closer to the correct synchronization signal, adjustment is made of the timing for taking-in the pattern from the serial data.

If once the synchronization signal is detected, it is set as the correct synchronization signal.

An example of the present invention, as applied to a DVD-RAM, will now be described. Referring to FIG. 2, physical sector data (SECTOR DATA) is arranged next to a header. The header includes a PA3, a guard 2, a buffer, a header, a mirror, a gap, a guard 1, VF03 and PS (Pre- Sync). Meanwhile, ‘1’ below PA3 denotes a one word length (16 bits). Thus, PS (Pre- Sync) is three words long.

With the DVD-RAM format, sector data are not consecutive. Moreover, the sector start position is shifted at random for preventing deterioration caused by repeated writing.

As for detection of a synchronization signal at the leading end of a sector in the DVD-RAM, it is difficult to generate a correct synchronization signal detection timing to high accuracy from the detection timing of the header region, routinely used as basis or reference, on account of this random shifting. It is therefore necessary to detect a synchronization signal at the leading end of a sector for correct data reproduction.

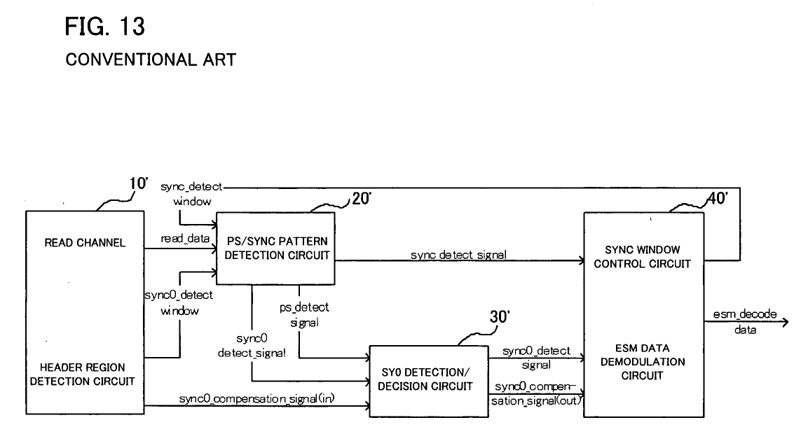

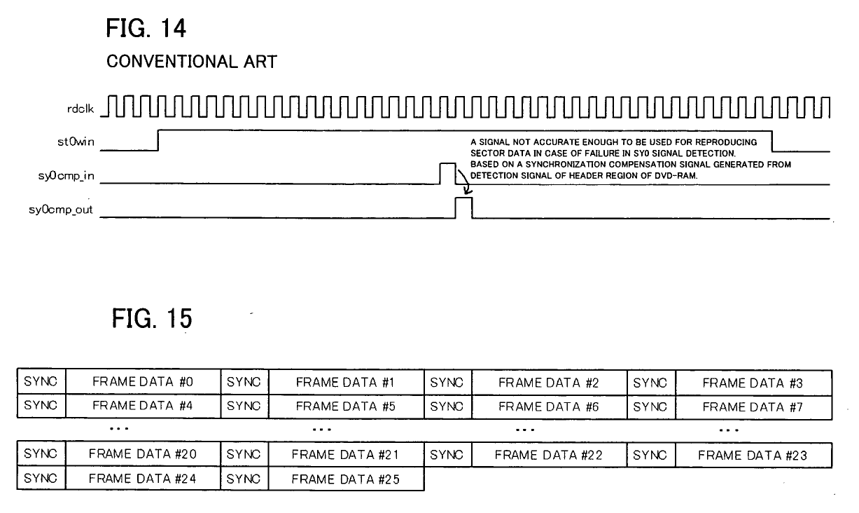

As shown in FIG. 13, with the conventional technique, in which, if the synchronization signal is not detected at the leading end of a sector, the reproduced data becomes error data until the detection of the synchronization signal.

According to the present invention, correctly reproduced data may be acquired, based on the serial data, even in case the synchronization signal cannot be detected. The detection of synchronization will now be described, taking the DVD-RAM as an example.

In the DVD-RAM, the PS (Pre- Sync) is recorded in a header (Header) ahead of a frame synchronization signal of sector data. The PS pattern, made up of three words (6 bytes=48 bits), is shown below:

### PS: 0000_{—}0100_{—}0100_{—}1000_{—}0010_{—}0001_{—}0010_{—}0000_{—}1000_{—}0010_{—}0001_{—}0000

The synchronization signal at the leading end of a sector (SY0) may, for example, be of a pattern shown below:

SY0: 0001_{—}0010_{—}0100_{—}0100_{—}0000_{—}0000_{—}0001_{—}0001

where it is noted that a SY0 pattern is made up of four bytes=32 bits and that several patterns other than the above pattern may be used as the synchronization signal SY0.

According to the present invention, such detection level which will take on the maximum value is generated in case of coincidence of the serial data with the synchronization signal SY0. For generating the detection level, the serial data of 10 bytes=80 bits are divided into ten (10) regions, every 8 bits, for matching to the PS/ SY0 pattern, where the PS pattern is constituted by 6 bytes=48 bits and the SY0 pattern is formed by 4 bytes=32 bits. The numbers corresponding to the result of the matching are used as the detection level. In case the serial data completely coincides with the synchronization signal, the detection level is 10 which is the maximum value. That is, each matched region is counted as score one and each non-matched region is counted as score zero. The total number of the scores obtained in the ten regions is used as the detection level. In case all of the ten regions are matched, the score is equal to 10.

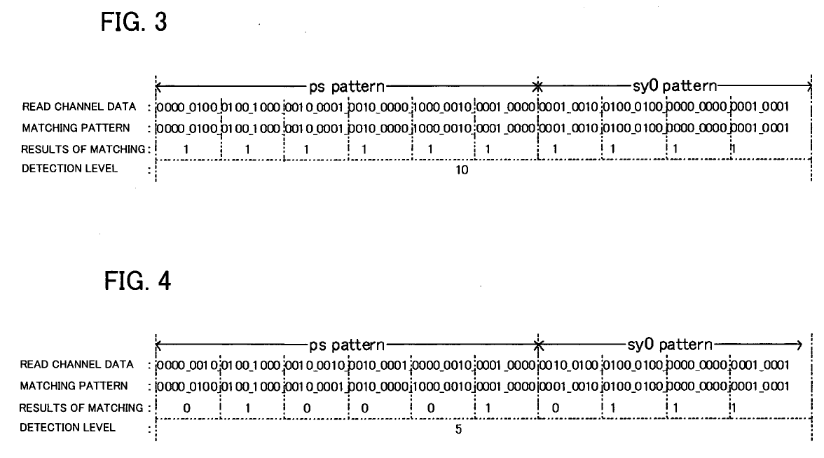

In the example shown in FIG. 3, the serial data from the read channel (read channel data) coincide with the pattern for matching, in all of the ten regions. In this case, the detection level is set to 10.

If, before detecting the synchronization signal pattern in the synchronization detection window, the maximum value of the past detection levels is lesser than 5, and the pattern with the detection level greater than 5 is detected, as shown in FIG. 4, the past detection level is updated, by way of detection of a provisional synchronization signal.

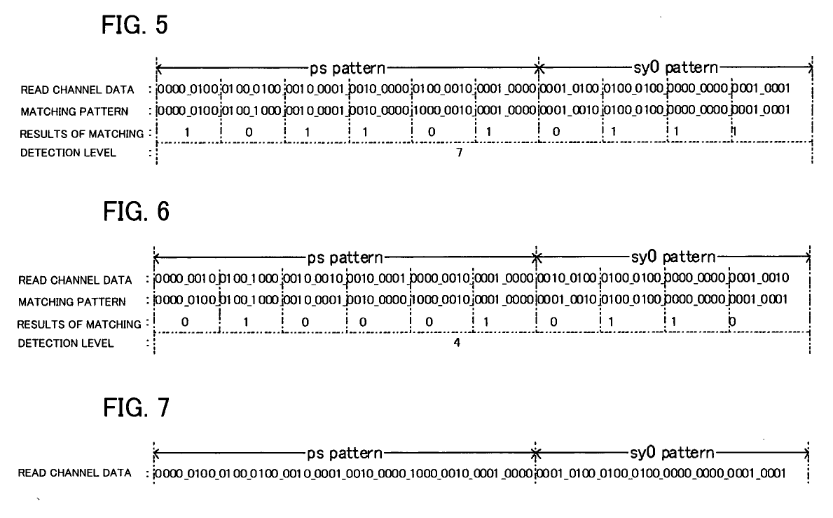

In similar manner, if a pattern having a detection level greater than the past detection level (detection level 7 in FIG. 5) is found, the past detection level is updated, by way of detection of a provisional synchronization signal.

If, as shown in FIG. 6, a pattern having the detection level lower than the past detection level (the level of 4 in FIG. 6) is detected, the past detection level is not updated, so that no provisional synchronization signal is detected.

If there is a pattern having the maximum detection level of 10 in the synchronization detection window, the past detection level is updated, by way of detecting a provisional synchronization signal. If a pattern with the detection level of 10 is subsequently detected, no provisional synchronization signal is detected. Meanwhile, if the detection level is 10, the synchronization signal is necessarily detected.

Thus, according to the present invention, there is the possibility of detecting a plural number of provisional synchronization signals during the time period prior to detection of the synchronization signal pattern in the synchronization detection window. At such time, the serial data take-in timing may be re-synchronized, as appropriate.

However, from the perspective of prohibiting erroneous detection, detection of 14T in the SY0, which is a pattern peculiar to the synchronization signal, is postulated, as a condition auxiliary to the aforementioned detection level. However, the 14T may occasionally become an error pattern.

As regards the detection of the synchronization signal pattern, a threshold value is set, based on the aforementioned detection level, and a pattern exceeding the threshold value is set as a synchronization signal pattern.

From the perspective of prohibiting erroneous detection, only the detection level prevailing at the time of detection of 14T of SY0, which is a unique pattern present only in the synchronization signal, is taken to be valid, as shown in FIG. 7.

There may be a case where bit inversion takes place during the aforementioned 14T pattern period of SY0, due e.g., to random errors, such that a pattern totally different from the presupposed 14T error pattern is generated. In such case, detection of SY0 14T may not be taken to be a condition for detection of a synchronization signal, as another method for detecting the synchronization signal. In such case, it is sufficient to design the synchronization detection circuit so that the circuit necessarily performs the following two synchronization detection operations:

As a first stage, before 14T detection, the synchronization detection operation is to be carried out based on the detection level for which detection of the SY0 14T is not a must.

As a second stage, after 14T detection, the synchronization detection operation is to be carried out based on the detection level for which detection of the SY0 14T is a must.

Whether or not the detection of 14T is to be a condition for synchronization detection/decision may be thought of as changing the weighting for the result of pattern matching in computing the detection level. For example, the aforementioned first stage sets a weight to the purport that 14T detection is not used for synchronization detection/decision, whilst the second stage sets a weight to the purport that 14T detection is an essential condition for synchronization detection/decision.

In particular, with the method for synchronization detection, in which 14T detection is not a must for synchronization detection/decision, the probability of erroneous detection becomes that high. In such case, it is possible to suppress the probability of erroneous detection,

(A) by increasing the weighting of the consecutively matched pattern portions, in case such consecutive pattern matching is achieved, or

(B) by providing a threshold value for synchronization detection/decision, as to the detection level, in the synchronization detection/decision,

instead of simply using the number of the matched pattern portions per se as the detection level in computing the detection level.

In this manner, several methods may be contemplated in calculating the detection level or in making synchronization detection/decision.

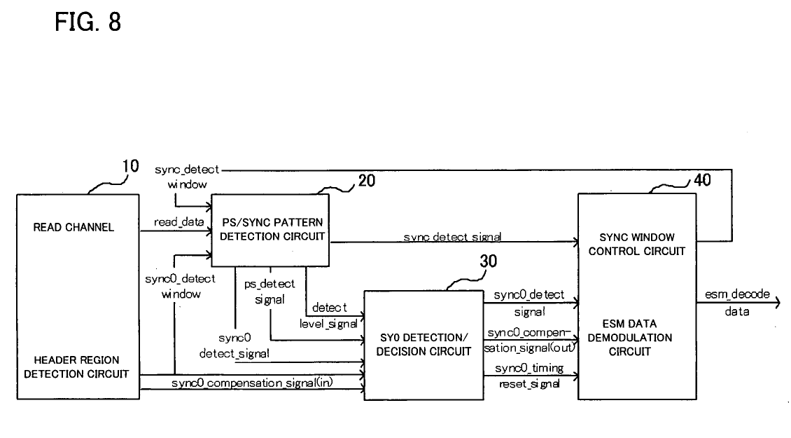

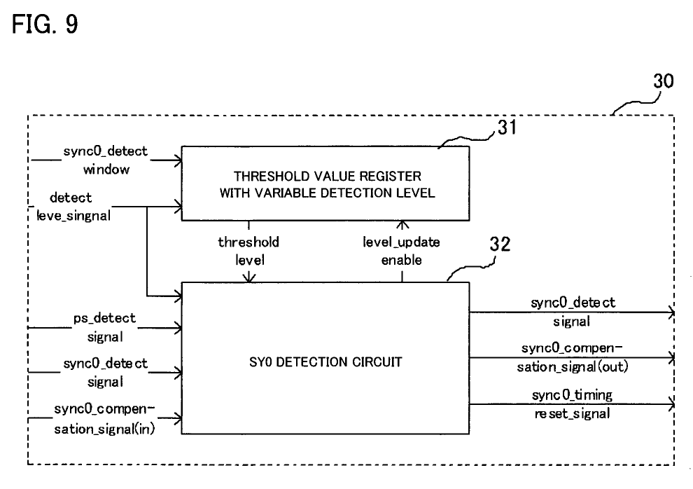

FIG. 8 shows the configuration of a detection circuit for detecting a synchronization signal (SY0 as a synchronization signal at the leading end of a sector of a DVD-RAM) according to an example of the present invention. FIG. 9 is a circuit diagram showing the configuration of an SY0 detection/decision circuit 30.

In FIGS. 8 and 9, the signal indicating the above-described detection level according to the present invention is detect_level_signal. A signal sync0_detect_signal denotes detection of a 14T pattern in the synchronization signal SY0 at the leading end of a sector. A signal sync0_timing_reset_signal indicates re-synchronization of the data take-in timing for the serial data.

A signal read_data, also termed read channel data, is serial data received from the read channel. A header area detection circuit of a circuit block 10 outputs sync0_detect_window (sy0win) for detecting the leading end of a sector estimated from the header of the serial data. The header area detection circuit outputs sync0_compensation_signal (in) (sy0 cmp_in), which is a synchronization compensation signal at the leading end of a sector as estimated from the header.

On detection from the serial data of a synchronization signal (SY0) at the leading end of a sector, a PS/SYNC pattern detection circuit 20 outputs sync0_detect_signal (sy0det). On detection of a PS (Pre Sync) pattern, the PS/SYNC pattern detection circuit outputs ps_detect_signal. The PS/SYNC pattern detection circuit 20 outputs the aforementioned detect_level_signal.

The SY0 detection/decision circuit 30 receives ps_detect_signal (ps_det), sync0_detect_signal (sy0det) and sync0_compensation_signal (in) (sy0_cmp_in) to output a SY0 detection signal sync0_detect_signal (sy0_det). In case the SY0 synchronization signal sync0_detect_signal (sy0det) cannot be obtained, the SY0 detection/decision circuit 30 outputs an SY0 compensation signal sync0_compensation_signal (out) (sy0 cmp_out). The SY0 detection/decision circuit 30 outputs a sync0 timing reset signal (tmgrst) as a signal for resetting (re-synchronizing) the take-in timing of the read channel data.

A SYNC window control circuit outputs sync_detect_window to the PS/SYNC pattern detection circuit. The ESM data demodulating circuit outputs ESM decoded data (esm_decode_data).

The signal sy0 cmp_out, generated by the SY0 detection/decision circuit 30, based on the SY0 compensation signal (sy0cmp_in), is used as a compensation signal for SY0.

The sync0 timing reset signal, output from the signal SY0 detection/decision circuit 30, is a read channel data take-in timing reset signal.

FIG. 9 is a circuit diagram showing the configuration of the SY0 detection/decision circuit 30. This SY0 detection/decision circuit 30 includes a threshold value register with variable detection level 31 and a SY0 detection circuit 32.

The threshold value register with variable detection level 31 receives the sync0_detect_window and the detect_level_signal to output threshold_level to the SY0 detection circuit 32. The signal threshold_level holds past threshold levels.

The SY0 detection circuit 32 receives detect_level_signal, ps_detect_signal, sync0_detect_signal and sync0_compensation_signal (in) and outputs level_update to the threshold value register with variable detection level 31, while outputting sync0_detect_signal, sync0_compensation_signal (out) and sync0_timing_reset_signal to the ESM demodulation circuit.

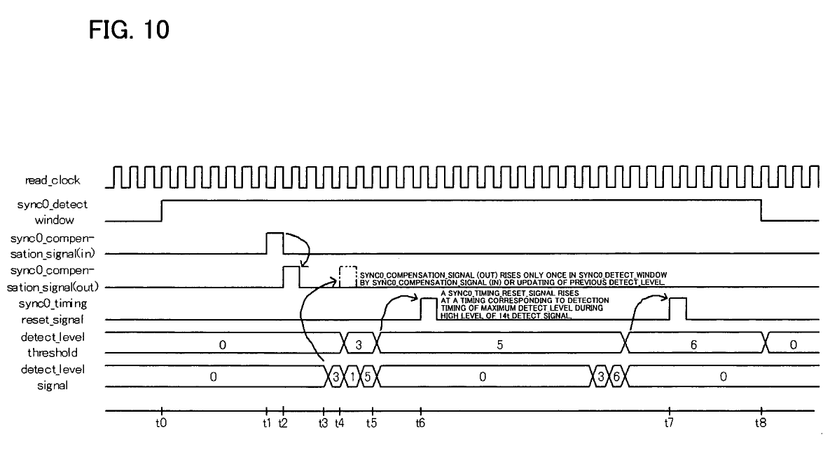

FIG. 10 is a timing chart for illustrating the operation of a synchronization detection circuit shown in FIGS. 8 and 9.

At a timing t0, when the signal sync0_detect_window, indicating a region at the leading end of a sector with high detection probability of the synchronization signal SY0, becomes HIGH, detection of the synchronization signal SY0 is commenced.

At timings t0-t1, the detection level detect_level_signal, generated from the results of detection of the synchronization signals 12T to 16T, is low, and hence the value of the variable threshold value threshold_level is not updated with the detection level detect_level_signal.

At a timing t2, when the signal sync0_compensation_signal (in) (sy0cmp_in), representing the rough SY0 signal position, is detected, the synchronization compensation signal sync0_compensation_signal (out), playing the role of advancing a base address or a frame address, is generated.

If, at a timing t3-t4, when the sync0_detect_signal becomes HIGH before detection of the synchronization compensation signal sync0_compensation_signal (in), the synchronization compensation signal sync0_compensation_signal (out) rises, with the rising of the sync0_detect_signal as reference.

At a timing t5, a signal detect_level_threshold takes on a maximum value (5 in FIG. 10) during the time detect_level_signal is in HIGH level.

At a timing t5, after a preset time as from updating of detect_level_threshold from 3 to 5, the signal which plays the role of resetting a frame address (sync0_timing_reset_signal) rises. The pulse signal sync0_timing_reset_signal is generated, based on a detection timing of the maximum detection level, during the time the 14T detection signal sync0_detect_window, as a 14T detection signal, remains HIGH in level.

At a timing t7, when detect_level_threshold is again updated, sync0_timing_reset_signal again rises, as in the timing t6.

At a timing t8, when sync0_detect_window goes LOW, the detection operation by the synchronization detection circuit ceases.

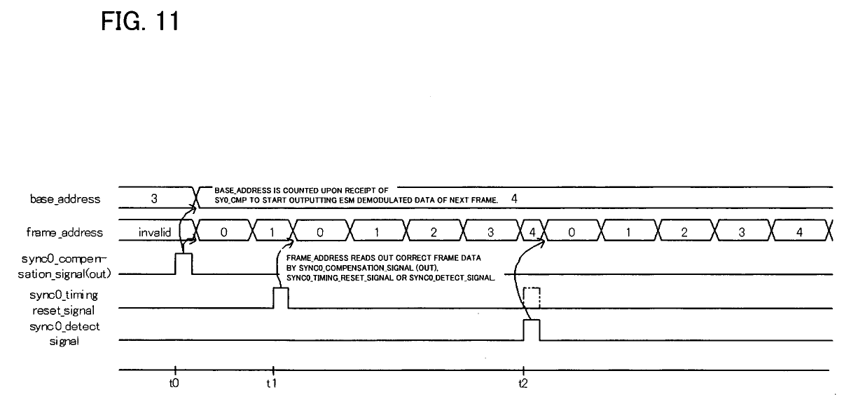

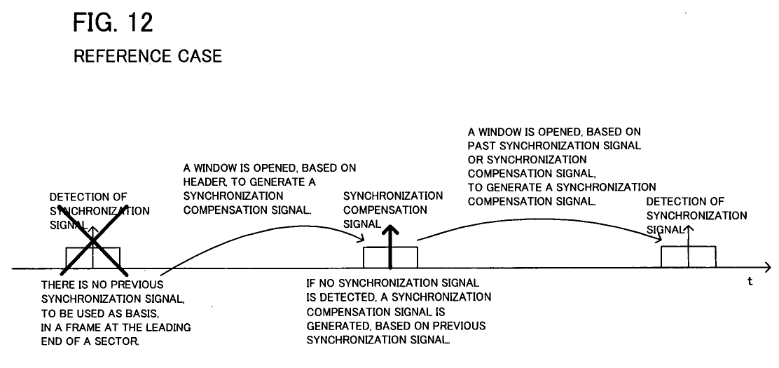

FIG. 11 depicts a chart showing the operation of resetting of the base address and the frame address in the present example.

At a timing t0, when the HIGH level (or transition from LOW to HIGH) of the signal sync0_compensation_signal (out) is detected, the base address base_address is counted up, while the frame address (frasme_address) is set to zero. The ESM demodulated data for the next frame commences to be output.

At a timing t1, when the HIGH level (or transition from LOW to HIGH) of the signal sync0_timing_reset_signal is detected, the frame address (frame_address) is set to 0.

At a timing t2, when the signal sync0_detect_signal is detected, the frame address (frame_address) is set to 0, as at the time of detection of sync0_timing_reset_signal.

According to the present invention, correctly reproduced data may be obtained, even in case the reproduced signal is deteriorated in quality such that it is difficult to detect the synchronization signal, as a result of which the drive may be improved in readability. The reason may be summarized as follows:

If, in detecting the synchronization signal SY0, at the leading end of a sector, the detection level of the synchronization signal is not higher than a threshold value pre-set for synchronization detection/decision, the reproducing timing usually cannot be obtained from the synchronization signal, so that the reproduced data becomes error data.

According to the present invention, reproduced data can be obtained correctly because serial data is captured based on a higher detection level even though a synchronization signal cannot be obtained.

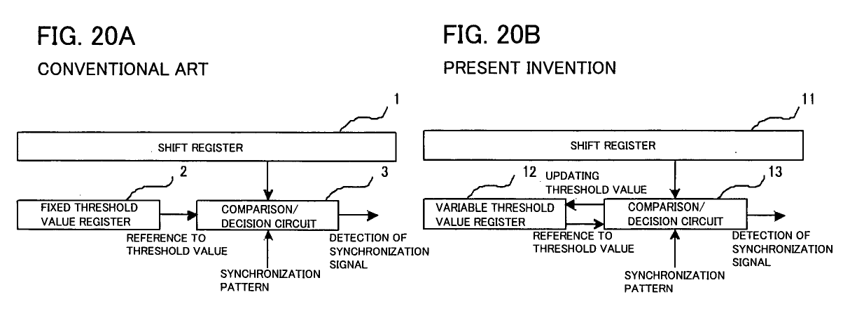

FIGS. 20A and 20B are diagrams for illustrating the present invention in comparison with the conventional configuration shown in e.g., Patent Document 1.

In Patent Document 1, a comparison/decision circuit 3 matches the data containing a read-out synchronization signal to a normal synchronization pattern, on the byte basis, as shown in FIG. 20A. There is provided a threshold value for the number of the matching events (fixed threshold value register 2). In case the number of the matching events exceeds the threshold value, it is taken to be synchronization detection and data is read out based on this assumed synchronization detection.

According to the present invention, consecutive matching operations are carried out in a region with high synchronization signal detection probability (i.e., in the window). If the number of events of coincidence between read channel data and data for matching at a certain time point is larger than the number of matching events which prevailed before the time point, such read channel data is taken to be a signal equivalent to the synchronization signal.

In this case, there are present plural signals equivalent to the synchronization signal. However, this is not of a problem since data readout is ultimately carried out based on the signal with the number of maximum matching events in the detection window. That is, according to the present invention, as shown in FIG. 20B, the comparison/decision circuit 13 updates the threshold value by referring to a variable threshold register 12.

In conventional circuit configurations, such as the configuration of Patent Document 1, the rate of detection and the rate of erroneous detection of the synchronization signal are basically in the relationship of tradeoff to each other. That is, in the conventional circuit configuration, if the threshold value is lowered, the rate of detection of the synchronization signal is lowered, however, the rate of erroneous detection is raised at the same time. If the threshold value is lowered, the rate of erroneous detection of the synchronization signal is lowered, however, the rate of detection of the synchronization signal is lowered at the same time. The present invention is not from this sort of the problem.

Depending on the standards, detection of the synchronization signal at the leading end of a sector represents an essential condition for correct reproduction of data at the leading end of a sector. For example, if the synchronization signal at the leading end of a sector of, for example, a DVD-RAM, is not detected, the data read out until detection of a synchronization signal, that is present as from the leading end of the sector in question, become error data in their entirety.

The conventional circuit configuration, inclusive of Patent publication 1, uses a fixed threshold value (see FIG. 20A). That is, signal patterns not higher than the threshold value cannot be taken to be synchronization signals.

According to the present invention, the signal pattern closest to the synchronization signal in the synchronization detection window is taken to be a signal equivalent to the synchronization signal. Hence, the data taken to be error data depending on setting condition in the conventional circuit may be reproduced correctly. This is conductive to improved drive readability.

Although the present invention has so far been explained with reference to the preferred examples, the present invention is not limited to the particular configurations of these examples. It will be appreciated that the present invention may encompass various changes or corrections such as may readily be arrived at by those skilled in the art within the scope and the principle of the invention.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A synchronization detection circuit for detecting a synchronization signal from serial data received, comprising:
a circuit that collates said serial data with a predetermined matching pattern, in a synchronization detection window, and that generates a detection level which takes on a value corresponding to the degree of conformity between said serial data and said matching pattern; and
a circuit that determines a pattern, the detection level of which exceeds a predetermined threshold value, to be a synchronization signal pattern, when such pattern is detected from said serial data.

2. The synchronization detection circuit according to claim 1, further comprising:
a circuit that retains a maximum value of a past detection level during the time before detection of a synchronization signal pattern; and
a circuit that updates, on detection of a pattern with a detection level thereof being higher than said maximum value, as retained, said past detection level, and based on a premise that the detection of the pattern with said higher detection level can be supposed to indicate detection of a provisional synchronization signal pattern, outputs a signal for re-synchronizing data take-in timing.

3. The synchronization detection circuit according to claim 1, wherein
a bit pattern corresponding to at least a synchronization signal at the leading end of a sector is divided into a plural number of regions, as matching patterns, each being of a preset bit length;
scores 1 or 0 are afforded in accordance with coincidence or non-coincidence with said matching pattern in each region, respectively; and
the sum of the scores for entirety of said regions of said matching patterns is set as said detection level.

4. The synchronization detection circuit according to claim 1, wherein
a bit pattern corresponding to concatenation of a pre-sync pattern provided in a header and a synchronization signal (SY0) pattern at the leading end of a sector is divided into a plural number of regions, as matching patterns, each being of a preset bit length;
scores 1 or 0 are afforded in accordance with coincidence or non-coincidence with said matching pattern in each region, respectively; and
the sum of the scores for entirety of said regions of said matching patterns is set as said detection level.

5. The synchronization detection circuit according to claim 1 wherein
said synchronization detection window corresponds to a time interval indicating a relatively high probability of detection of a synchronization signal.

6. A recording and/or reproducing apparatus comprising a synchronization detection circuit as set forth in claim 1.

7. A method for synchronization detection comprising the steps of:
generating a synchronization compensation signal when a window for a synchronization signal (SY0) at the leading end of a sector is opened;
detecting a pattern proximate to the synchronization signal and comparing a pattern detected with a pattern detected in the past;
adjusting data take-in timing from said serial data in case the pattern as newly found is determined to be more proximate to the correct synchronization signal; and
setting the synchronization signal, detected by said previous step, as a correct synchronization signal.

8. A method for synchronization detection comprising the steps of:
receiving input serial data and a synchronization detection window indicating a region of a high probability of detection of a synchronization signal, as input;
collating said input serial data with a predetermined matching pattern, in the synchronization detection window, and generating a detection level which takes on a value corresponding to the degree of conformity between said serial data and said matching pattern; and
determining a pattern, the detection level of which exceeds a predetermined threshold value, to be a synchronization signal pattern, when such pattern is detected from said serial data.

9. The method according to claim 8, further comprising the steps of:
retaining a maximum value of a past detection level during the time before detection of a synchronization signal pattern;
updating said past detection level in case a bit pattern with the detection level thereof being higher than said maximum value, as retained, is detected, and based on a premise that the detection of the pattern with said higher detection level can be supposed to indicate detection of a provisional synchronization signal pattern, re-synchronizing data take-in timing.

10. The method according to claim 8, wherein
a bit pattern corresponding to at least a synchronization signal (SY0) at the leading end of a sector is divided into a plurality of regions, as matching patterns, each being of a preset bit length;
scores 1 or 0 are afforded in accordance with coincidence or non-coincidence with a matching pattern in each region, respectively; and
the sum of the scores for entirety of said regions of said matching patterns is set as said detection level.

11. The method according to claim 8, wherein
a bit pattern corresponding to concatenation of a pre-sync pattern provided in a header and a synchronization signal (SY0) pattern at the leading end of a sector is divided into a plural number of regions, as matching patterns, each being of a preset bit length;
scores 1 or 0 are afforded in accordance with coincidence or non-coincidence with a matching pattern in each region, respectively; and
the sum of the scores for entirety of said regions of said matching patterns is set as said detection level.
